(19) United States
(12) Patent Application Publication
(10) Pub. No.: US 2025/0170457 A1
(43) Pub. Date: May 29, 2025

(54) GOLF BALL CORE INCLUDING RADAR DETECTABLE COMPONENT

(71) Applicant: Acushnet Company, Fairhaven, MA (US)

(72) Inventors: Matthew F. Hogge, Plymouth, MA (US); Edward Costa, East Providence, RI (US); Nelson J. Araujo, South Dartmouth, MA (US); Dennis Britton, North Dartmouth, MA (US)

(73) Assignee: Acushnet Company, Fairhaven, MA (US)

(21) Appl. No.: 18/522,300

(22) Filed: Nov. 29, 2023

(51) Int. Cl. A63B 37/00; A63B 43/00; C08L 9/00

(52) U.S. Cl. CPC A63B 37/0051; C08L 9/00; A63B 37/0074; A63B 37/0075; A63B 43/004; A63B 2209/00

(57) ABSTRACT

A golf ball including a radar detectable component that is integrated with the core of the golf ball is disclosed herein. In one aspect, the radar detectable component can be embodied as a structural portion of the core itself. In one aspect, the radar detectable component is embodied as a modified rubber composition that is different than a base rubber composition for a remainder of the core body and instead includes a concentration of radar reflective material. In another aspect, the core body includes at least one void that is configured to receive and retain radar reflective material. The radar detectable component can be arranged on or within the core without requiring any ink-based or printing-based techniques.

### FIELD OF THE INVENTION

This disclosure generally relates to a golf ball, and is more particularly related to a golf ball core including a radar detectable component.

### BACKGROUND OF THE INVENTION

Radar tracking of golf balls continues to be an area of interest for both amateur and professional golfers alike. Ink-based or printing techniques are known for applying radar detectable marks to a golf ball or sub-components of a golf ball. While these techniques are effective, the printing steps require manufacturing techniques which can be relatively complex due to the requisite high level of precision, printing machinery, and/or imaging equipment.

It would be desirable to provide a technique for incorporating a radar detectable component into a golf ball that does not require printing.

### SUMMARY OF THE INVENTION

In some embodiments, the present disclosure is directed to a radar detectable component that is integrated within a golf ball construction. More specifically, in one aspect, the present disclosure is directed to incorporating a radar detectable component within a core of a golf ball. In one aspect, the present disclosure is directed to incorporating a radar detectable component in layers other than a casing layer or cover layer of a golf ball. In one aspect, the present disclosure is directed to avoiding printing steps associated with typical radar detectable ink techniques. For example, the present disclosure provides a configuration in which radar detectable features can be integrated directly within the core via various formation techniques, thereby saving costs or manufacturing steps associated with application of radar detectable features on outer layers from the core.

In one example, a golf ball is disclosed that includes a core comprising at least one radar detectable component. The core defines a radially outermost surface and the at least one radar detectable component can be at least one of: (i) coincident with at least a portion of the radially outermost surface, or (ii) radially inward from the radially outermost surface.

In one aspect, the radar detectable component is embedded at a depth of at least 10% of a diameter of the core. In one aspect, the radar detectable component is embedded at a depth of at least 15% of a diameter of the core. In one aspect, the radar detectable component is embedded at a depth of 0.1%-40% of a diameter of the core.

In one aspect, the radar detectable component can be flush with the spherical radially outermost surface of the core. In another aspect, the radar detectable component can be embedded and/or encapsulated within the core. Other configurations for the radar detectable component are disclosed herein. The golf ball can further comprise at least one intermediate layer and a cover disposed about the core. In one aspect, the core can be a single core, dual core, tri-core, or have more than three layers. In one aspect, the core is otherwise structurally intact or unmodified as compared to a typical, solid golf ball core.

The radar detectable component can be comprised of a composition including a base rubber composition and a secondary rubber composition including a radar reflective additive.

The base rubber composition and the secondary rubber composition can be simultaneously co-molded with each other. In one aspect, a prep or pre-molded body of the base rubber composition and a prep of the secondary rubber composition can be loaded into a core molding assembly simultaneously and fuse to form the core body. In one aspect of this co-molding process, the core does not require any secondary processing steps, such as cutting or removal of material to create space for the radar detectable component.

The base rubber composition can be molded during a first molding step, and the secondary rubber composition can be molded during a second molding step that is different than the first molding step.

The radar detectable component can be comprised of at least one radar reflective body that is embedded within a base rubber material of the core. The at least one radar reflective body can include a first radar reflective body and a second radar reflective body. The first radar reflective body can be arranged at a first radial depth within the core and the second radar reflective body can be arranged at a second radial depth within the core, and the first and second radial depths can be different. In one aspect, the radial depths can be identical but the orientation of the first and second radar reflective bodies can differ. In another aspect, the radial depths and orientations can be identical but the dimensions of the first and second radar reflective bodies can differ.

The radar reflective body can include at least one metallic body. The metallic body can be formed as a cylindrical body in one example. In another example, the metallic body can be an irregularly shaped piece or chunk. One of ordinary skill in the art would understand that various shapes for the metallic body can be used. In one aspect, the metallic body can be metallic or semi-metallic. In one aspect, the radar reflective body can be formed from a non-metallic material. In one aspect, the radar reflective body can be comprised of silver, electrically conductive carbon, aluminum, graphene, nanotubes, nanometals, and combinations of two or more thereof.

The radar detectable component can be disposed within at least one channel defined on the radially outermost surface of the core.

In one example, a radially outer surface of the at least one radar detectable component and the radially outermost surface of the core define a contiguous radially outer perimeter of the core.

The radar detectable component can be a non-printed and/or non-ink based radar detectable component.

A method of forming a golf ball with at least one radar detectable component is also disclosed herein. The method can comprise (i) forming a core such that at least one radar detectable component is at least one of: coincident with a radially outermost surface of the core, or radially inward from the radially outermost surface of the core; and (ii) forming a cover around the core.

In one example, step (i) can further comprise forming the core from a composition including a base rubber composition and a secondary rubber composition including a radar reflective additive.

In one example, step (i) can further comprise simultaneously co-molding the core and the radar detectable component with each other.

In one example, step (i) can further comprise forming the core separately from the radar detectable component.

The radar detectable component can be comprised of at least one radar reflective body, and step (i) can further comprise embedding the at least one radar reflective body within a base rubber material of the core.

The at least one radar reflective body can be comprised of at least one metallic body. The metallic body can have a cylindrical profile, in one example.

In one example, step (i) can further comprise forming the core such that at least one channel is defined on the radially outermost surface of the core, and overmolding the radar detectable component with the core such that the radar detectable component at least partially fills the at least one channel.

In one aspect, the radar detectable component is not a printed-based or ink-based radar detectable component.

Additional features and aspects of the present disclosure are described in further detail herein.

### BRIEF DESCRIPTION OF THE DRAWINGS

Further features and advantages of the present disclosure can be ascertained from the following detailed description that is provided in connection with the drawings described below:

FIG. 1A is a cross-sectional view of a golf ball core according to one aspect.

FIG. 1B is a cross-sectional view of a golf ball core including voids according to one aspect.

FIG. 1C is a cross-sectional view of an assembled golf ball including the golf ball core of FIGS. 1A and 1B.

FIG. 1D is a magnified view of a portion from FIG. 1C.

FIG. 2A is an illustration of a step for forming a golf ball core with a radar detectable component according to one aspect.

FIG. 2B is an illustration of another step for forming a golf ball core with a radar detectable component according to one aspect.

FIG. 2C is an illustration of a golf ball core with an embedded radar detectable component.

FIG. 2D is an illustration of a golf ball with the core having the embedded radar detectable component of FIG. 2C.

FIG. 3A is an illustration of a golf ball core according to one aspect.

FIG. 3B is an illustration of the golf ball core of FIG. 3A with a section removed.

FIG. 3C is an illustration of the golf ball core of FIG. 3B with a radar detectable component prep arranged within the removed section of the golf ball core.

FIG. 3D is a cross-sectional view of a golf ball according to one aspect.

FIG. 4 illustrates a golf ball core according to one aspect.

FIG. 5 illustrates a golf ball core according to one aspect.

FIG. 6 illustrates a golf ball core according to one aspect.

FIG. 7 is an illustration of a golf ball with the core having a plurality of embedded radar detectable components.

### DETAILED DESCRIPTION OF THE INVENTION

In each of the examples disclosed herein, the radar detectable features are arranged in such a manner that the radar detectable features are configured to be detected by a radar capture device regardless of how the golf ball is oriented. Stated differently, no matter how the golf ball is positioned on a tee or ground surface and subsequently struck, the associated radar capture device is configured to register a signal from the radar detectable features of the golf ball within the requisite time and spatial window to obtain data regarding the golf ball trajectory, speed, rotation, etc.

Various patterns for the radar detectable features can be used, as one of ordinary skill in the art would appreciate in view of U.S. Patent Application Pub. 2023/0249034, and U.S. Patent Application Pub. 2023/0095376, which are each commonly assigned to Acushnet Company and are each fully incorporated in their entirety as if fully set forth herein.

In one aspect, a golf ball is disclosed that has at least one radar detectable mark or feature such that a projected pattern is formed when the radar detectable mark or feature is radially projected onto an outer surface of the golf ball. In one aspect, the projected pattern can be formed by a plurality of longitudinal stripes formed from radar detectable material that are arranged asymmetrically about the golf ball. In another aspect, the projected pattern can form a crossing pattern or “X” shaped pattern, which can be symmetrical or asymmetrical. In another aspect, the projected pattern can be formed via a plurality of discrete radar detectable elements, such as dots, that are arranged asymmetrically about the golf ball.

In some examples described herein, a radar detectable component, marking, feature, or other element can be molded into various shapes and/or patterns onto a radially outer surface of the core. In one aspect, this configuration can be achieved via using tooling to form a channel, indentation, or other void on the core body and then overmolding with a radar detectable material or composition. The modified core body can then undergo known finishing techniques, such as centerless grinding, to restore the core body to its original size and spherical profile.

In one example, the radar detectable component can be embodied as strips, rods, or other pieces that are embedded within the core. Subsequent overmolding or other steps can be performed such that the strips, rods, or pieces are not visible from the outside of the core.

In another example, an excess of radar detectable metal powder or other radar detectable material can be applied to a specific outer surface, region, or section of the core. The metal substance or powder, or other radar detectable material can be deposited within voids defined on an outer surface of the core, or can be specifically arranged in a concentrated pocket within the core. The voids can either be intentionally molded with the initial core body or can be formed via subsequent machining steps to an already formed spherical core body.

In one aspect, the radar detectable material can include copper, zinc, zinc oxide, magnesium, tungsten, and/or silver-coated copper. In one example, the radar detectable material includes a rubber composition, such as polybutadiene-based rubber. One of ordinary skill in the art would understand that other rubbers could be used. In one aspect, the radar detectable material includes a rubber composition that includes an excess of at least one of copper, zinc, zinc oxide, magnesium, tungsten, silver, or silver-coated copper. As used in this context, the term excess can mean 25-40 phr, or 20-50 phr, or at least 20 phr, or at least 25 phr, or at least 30 phr. Various other materials could be used for the radar detectable material, such as electrically conductive carbon, aluminum, graphene, nanotubes, nanometals, and combinations of two or more thereof. In one aspect, the radar reflective material can be formed from any material, including, but not limited to, any radar reflective material disclosed in U.S. Provisional Patent Application No. 63/530,541, filed on Aug. 3, 2023, which is fully incorporated in its entirety as if fully set forth herein.

In another example, the radar detectable component can be integrated into the core via molding at least two skinny preps (also known as a preform or slug) simultaneously to form the core body. As used in this context, the term “skinny prep” can refer to a prep that represents a portion of the total workpiece, which in this case can be the core body. At least a first one of the skinny preps is formed from a composition including radar reflective material. The second skinny prep can be formed from typical rubber core formulations. In one example, multiple skinny preps having the radar reflective material can be used, and the multiple skinny preps comprising radar reflective material can be arranged asymmetrically relative to the non-radar reflective material skinny prep. In this manner, the resulting core body (i.e., workpiece) will have a composition that includes asymmetrically arranged patches or portions of radar reflective material.

In another example, a rubber core prep can be formed into an initial core body, and the core body can be cut or otherwise have a section removed to define a pocket or void, and a secondary rubber prep including the radar reflective material can be inserted into the pocket or void. A modified core body can then be formed via molding the secondary rubber prep with the initial core body.

In another example, a rubber core prep can be formed into an initial core body, and subsequent targeted cutting, drilling, grinding or other material removal steps can be applied to the initial core body to remove material in a predetermined pattern, and subsequent overmolding can be carried out to fill in the predetermined pattern with a material including the radar reflective material or component.

In another example, an initial core body can be formed that includes a void defining a predetermined pattern. The void can be formed via molding the initial core body to have this feature, or the initial core body can be modified via cutting, drilling, grinding or other process to define the void. In one example, the void can be formed via an indentation or other shape formed in the molds or tooling for forming the core. In a subsequent step, a radar reflective material, which can preferably be molten, can be directed into or applied within the void. The radar reflective material can then be cooled, or otherwise hardened or set. Subsequent steps, such as overmolding can be carried out to ensure the core body is spherical and account for any out of round portions caused by the void and application of radar reflective material. This aspect differs from other aspects disclosed herein in which the radar detectable component is formed from a rubber material that has a relatively high concentration of radar reflective material. Instead, this aspect does not require any rubber for the radar detectable component. In one aspect, the material used for the core can be formed from a high temperature polymer, such as silicone, and the radar reflective material can be formed from a relatively lower melting point metal. One of ordinary skill in the art would understand that the specific materials for forming the core and radar detectable component can vary.

In one aspect, the radar reflective material can completely fill the void or other channel formed on the surface of the core. Stated differently, the radar reflective material does not require any additional adhesive or filler type material to secure the radar reflective material to the core. Additionally, the durability of the golf ball is maintained in one aspect based on the void or channel being filled in with a secondary rubber composition and radar reflective material, or radar reflective material by itself that mimics the characteristics of the core material.

In one example, a golf ball is disclosed that includes a core comprising at least one radar detectable component. The core can define a radially outermost surface and the at least one radar detectable component can be at least one of: (i) coincident with at least a portion of the radially outermost surface, or (ii) radially inward from the radially outermost surface. In one aspect, the radar detectable component can be flush with the spherical radially outermost surface of the core. In another aspect, the radar detectable component can be embedded or encapsulated within the core. In one aspect, the at least one radar detectable component is radially inward from the radially outermost surface, such that a gap is defined between the radially outermost surface of the core and the at least one radar reflective body. The gap can be no greater than 0.001 inches in one aspect. In another aspect, the gap can be no greater than 0.010 inches. In another aspect, the gap can be no greater than 0.10 inches. In another aspect, the gap is at least 0.001 inches. In another aspect, the gap is at least 0.050 inches. In another aspect, the gap is at least 0.10 inches.

In one aspect, the radar detectable component is embedded at a depth of at least 10% of a diameter of the core. In one aspect, the radar detectable component is embedded at a depth of at least 15% of a diameter of the core. In one aspect, the radar detectable component is embedded at a depth of 0.1%-40% of a diameter of the core. The depth of the radar detectable component can be measured as a minimum distance between any portion of the radar detectable component and a radially outermost surface of the core.

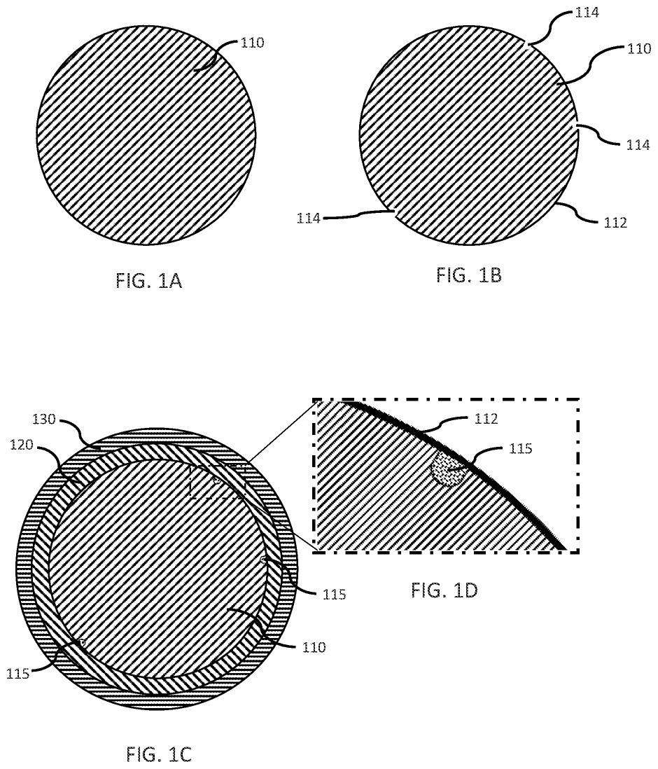

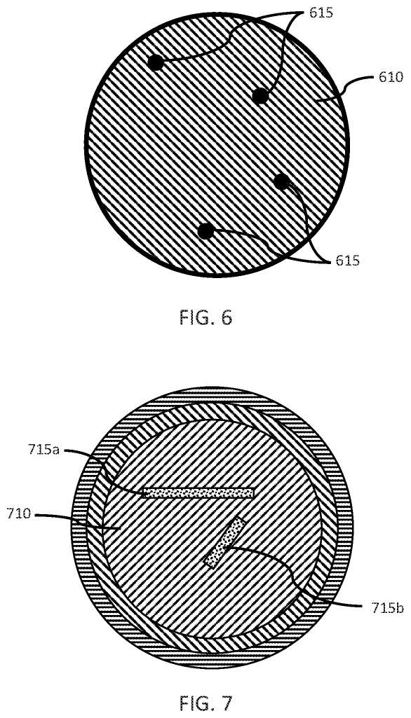

FIGS. 1A-1D illustrates one example for arranging a radar detectable component 115 within a core 110. In one aspect, the radar detectable component 115 is coincident with at least a portion of the radially outermost surface 112 of the core 110. A core 110 can be formed during an initial step. In one example, the core 110 can be initially formed with voids 114 configured to receive the material for the radar detectable component 115. For example, the core 110 can be formed from a mold or tooling that includes protrusions to define the voids 114 around the radially outermost surface 112 of the core 110. In another example, the core 110 can be formed as a spherical body (i.e., from molds or tooling that are spherical) and without voids (illustrated in FIG. 1A), and a subsequent cutting or other material removing step can be carried out to create the voids 114 (illustrated in FIG. 1B). In one aspect, the voids 114 can be elongated channels. In one aspect, the voids 114 can have cross-sections forming any shape. Various non-limiting exemplary shapes or profiles for the radar detectable component are shown in FIGS. 4-6.

The radar detectable component 115 can be formed from a modified rubber material, that is different from the rubber formulation used to form the core 110. As used in this context, the term modified rubber material can mean a rubber material including at least some concentration of radar reflective material. The modified rubber material for forming the radar detectable component 115 can be inserted, injected, disposed, or otherwise arranged within the voids 114 on the core 110, and the modified rubber material can then be cured, set, cooled, hardened, etc., to form a unitary core 110 with the radar detectable component 115. In one aspect, the rubber material including radar reflective material for forming the radar detectable component 115 can be overmolded with the previously formed core 110. In another aspect, the material including the radar reflective material does not have to include any rubber and can instead be provided as a molten radar reflective material that can be dispensed, injected, poured, disposed, or otherwise arranged within the voids 114 of the core 110, and subsequently cooled. In one example, a volume of the voids and a volume of the radar reflective material can be equal. In another example, the volume of the voids can be greater than the volume of the radar reflective material. One of ordinary skill in the art would understand that additional overmolding of a base rubber material can be carried out to ensure the core 110 has a spherical profile. The core 110 can be disposed within a casing 120 and a cover 130, as shown in FIG. 1C. One of ordinary skill in the art would understand that a single cover layer could encapsulate the core 110 instead of the casing 120 and the cover 130, or more than two layers can encapsulate the core 110. The arrangements disclosed herein can be adapted for golf balls of various construction types.

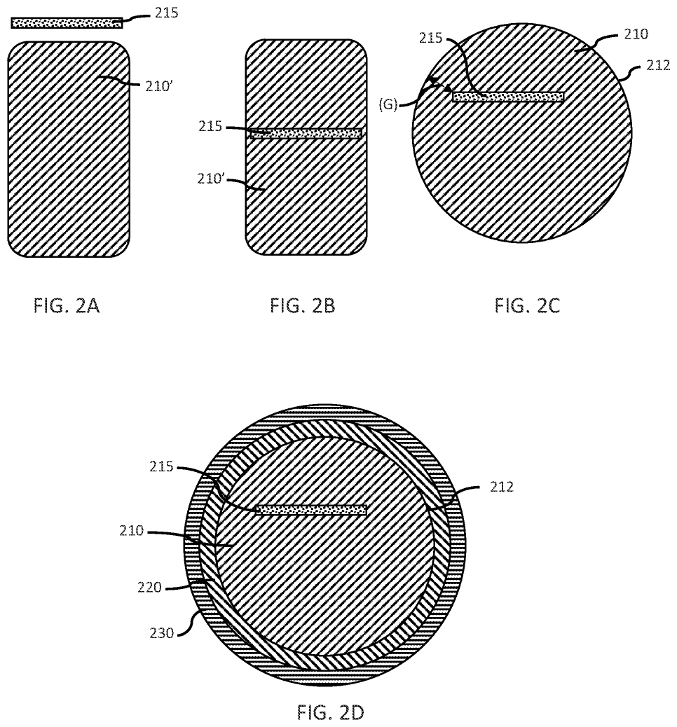

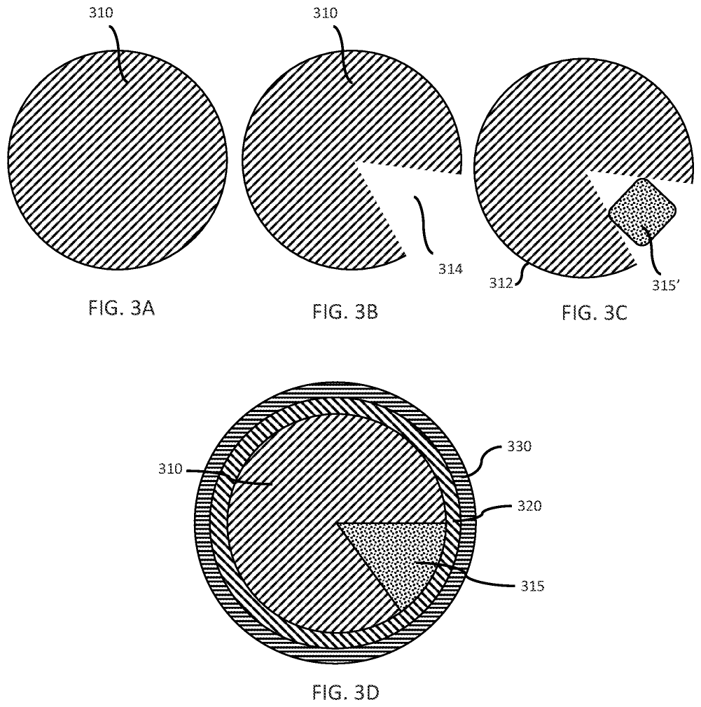

FIGS. 2A-2D illustrate various steps for forming a golf ball core 210 in which a radar detectable component 215 is ultimately disposed radially inward from the radially outermost surface 212 of the core 210. As shown in FIG. 2A, a core prep 210′ and a separately formed radar detectable component 215 can be provided in an initial step. The radar detectable component 215 can be embodied as a metallic, or radar reflective body or component, in one example. In another example, the radar detectable component 215 can be embodied as a rubber component with radar reflective material integrally arranged therein. In one aspect, the radar detectable component 215 can be inserted into a core prep 210′ prior to molding, and the core 210 can be subsequently molded with the radar detectable component 215 embedded therein. FIG. 2B shows an exemplary pre-molded state for the core prep 210′ with the radar detectable component 215 embedded therein. FIG. 2C shows a subsequent step in which the core prep 210′ is molded into the core 210 with the radar detectable component 215 embedded therein.

As shown in FIG. 2C, the embedded radar detectable component 215 can be off center relative to the core 210. In other examples, the embedded radar detectable component 215 can be centered relative to the core 210. One of ordinary skill in the art would understand that various configurations for the arrangement including embedded or encapsulated radar detectable components could be used. In one aspect, the radar detectable component is positioned radially inward from an outer surface of the core by at least 0.10 inches. In another aspect, the radar detectable component is positioned radially inward from an outer surface of the core by 0.10 inches-0.75 inches. In another aspect, the radar detectable component 215 is embedded at a depth of at least 10% of a diameter of the core 210. In one aspect, the radar detectable component 215 is embedded at a depth of at least 15% of a diameter of the core 210. In one aspect, the radar detectable component 215 is embedded at a depth of 0.1%-40% of a diameter of the core 210. In one aspect, the radar detectable component 215 is embedded at a depth of 25%-45% of a diameter of the core 210. A gap (G) between the radar detectable component 215 and the radially outermost surface 212 of the core 210 is shown in FIG. 2C.

In one aspect, the mass of the radar detectable component 215 can be selected to ensure that the subsequently molded core 210 with the embedded radar detectable component 215 exhibits an acceptable degree of symmetry with respect to mass distribution across the core 210. For example, the density of the radar detectable component 215 can be configured to mimic the density of the rubber composition for forming the core prep 210′. In one aspect, these two densities can be within 0.5%-10.0% of each other, or within 0.1%-10.0% of each other.

As shown in FIG. 2D, a casing 220 can be disposed about the core 210, and a cover 230 can be disposed about the casing 220. One of ordinary skill in the art would understand that a single cover layer could encapsulate the core 210 instead of the casing 220 and the cover 230, or more than two layers can encapsulate the core 210. The arrangements disclosed herein can be adapted for golf balls of various construction types.

In another configuration shown in FIG. 7, a plurality of radar detectable components 715a, 715b can be provided within a core 710. The golf ball shown in FIG. 7 is otherwise identical to the golf ball of FIG. 2D. As shown in FIG. 7, a first radar detectable component 715a is arranged at a first radial depth within the core 710, a second radar detectable component 715b is arranged at a second radial depth within the core 710, and the first and second radial depths are different. The radial depths can be measured as a minimum distance from the radially outermost surface of the core 710.

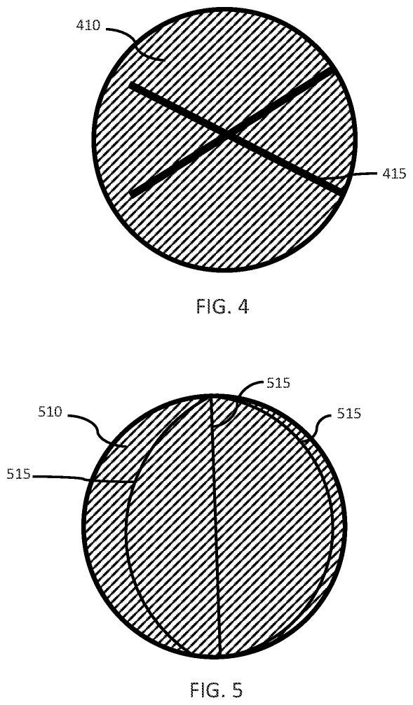

Referring to FIGS. 3A-3D, in another example, the radar detectable component 315 can be formed as a relatively larger segment of the core 310. In one aspect, preps of the core and the radar detectable component can be co-molded with each other to form the core 310 with the integrated radar detectable component 315. In another aspect, the core 310 can be formed in a separate step (FIG. 3A), and a section or portion of the core 310 can be removed to create a void 314 (FIG. 3B). Next, as shown in FIG. 3C, an uncured radar detectable component prep 315′ can be inserted into the void 314 of the core 310, and subsequently molded and/or cured. As shown in FIG. 3D, a casing 320 can be disposed about the core 310, and a cover 330 can be disposed about the casing 320. One of ordinary skill in the art would understand that a single cover layer could encapsulate the core 310 instead of the casing 320 and the cover 330, or more than two layers can encapsulate the core 310. The arrangements disclosed herein can be adapted for golf balls of various construction types. In one aspect, a total volume of the core 310 can be comprised of 10%-40% by volume of the radar detectable component 315. In another aspect, a total volume of the core 310 can be comprised of 20%-35% by volume of the radar detectable component 315. In another aspect, a total volume of the core 310 can be comprised of at least 20% by volume of the radar detectable component 315. In another aspect, a total volume of the core 310 can be comprised of at least 30% by volume of the radar detectable component 315. In another aspect, a total volume of the core 310 can be comprised of no greater than 50% by volume of the radar detectable component 315. In another aspect, a total volume of the core 310 can be comprised of no greater than 40% by volume of the radar detectable component 315. In one aspect, the radar detectable component 315 is coincident with at least a portion of the radially outermost surface 312 of the core 310.

In one aspect, the term coincident as used herein means that a radially outermost surface of the radar detectable component is radially aligned with the radially outermost surface of the core. Stated differently, the radar detectable component does not project radially beyond the radially outermost surface of the core. Exemplary coincident configurations are shown at least in FIGS. 1D and 3D.

FIGS. 4-6 are provided to show additional exemplary patterns for the radar detectable component(s) on the core. These exemplary patterns are non-limiting and provided for illustrative purposes. Additional exemplary patterns are disclosed in U.S. Patent Application Pub. 2023/0249034, and U.S. Patent Application Pub. 2023/0095376, which are each commonly assigned to Acushnet Company and are each fully incorporated in their entirety as if fully set forth herein. The length, width, diameter, and other size characteristics of the patterns shown in FIGS. 4-6 can vary, as one of ordinary skill in the art would understand.

As shown in FIG. 4, the radar detectable component 415 can form an X-shaped profile or pattern on the core 410. One of ordinary skill in the art would understand that other patterns could be used. In one aspect, the radar detectable component 415 can be formed from molten radar reflective material that is deposited or otherwise dispensed to fill an X-shaped void on the core 410. In one aspect, the radar detectable component 415 can be provided at two or more different radial depths within the core 410.

As shown in FIG. 5, the radar detectable component 515 can be comprised of a plurality of longitudinally extending strips arranged on and/or within the core 510. The radar detectable components 515 can be arranged asymmetrically about the core 510. One of ordinary skill in the art would understand that other patterns could be used. In one aspect, the radar detectable components 515 can be arranged at different radial depths. In one aspect, the radar detectable components 515 can be formed from molten radar reflective material that is deposited or otherwise dispensed to fill strip-like voids on the core 510.

As shown in FIG. 6, the radar detectable components 615 can be comprised of a plurality of discrete segments that are arranged around and/or within the core 610. The radar detectable components 615 can be formed via a plurality of preps of rubber materials with radar reflective material that are molded with the core 610. The radar detectable components 615 can be comprised of four asymmetrically arranged dots on and/or within the core 610, in one example. One of ordinary skill in the art would understand that other patterns could be used. In one aspect, the radar detectable components 615 can be formed from molten radar reflective material that is deposited or otherwise dispensed to fill dot-like voids on the core 610. In one aspect, the radar detectable components 615 can be arranged at various radial depths within the core 610.

Other configurations for the radar detectable component are disclosed herein. The golf ball can further comprise at least one intermediate layer and a cover disposed about the core. In one aspect, the core can be a single layer core, dual core, tri-core, or have more than three layers.

The radar detectable component can be comprised of a composition including a base rubber composition and a secondary rubber composition including a radar reflective additive. In one aspect, the base rubber composition and the secondary rubber composition are segregated such that the two compositions do not mix with each other, but combine to define a composite core body. The location of the secondary rubber composition can be specifically configured to be detectable via radar tracking systems or components regardless of how the golf ball is oriented. In one aspect, the base rubber composition and the secondary rubber composition are immiscible.

The base rubber composition and the secondary rubber composition can be simultaneously co-molded with each other, in one example. In another example, the base rubber composition can be molded during a first molding step, and the secondary rubber composition can be molded during a second molding step that is different than the first molding step.

In one example, the radar detectable component can be comprised of at least one radar reflective body that is embedded within a base rubber material of the core. One such exemplary configuration is shown in FIG. 2D. The quantity of radar reflective bodies can vary, as one of ordinary skill in the art would appreciate. In one aspect, a plurality of radar reflective bodies can be embedded within the core and can be arranged in an asymmetrical pattern. In one aspect, an odd number of radar reflective bodies can be embedded within the core. In one aspect, an even number of radar reflective bodies can be embedded within the core. In one aspect, a plurality of radar reflective bodies can be embedded within the core at varying radial depths and/or circumferential positions.

The radar reflective body can include at least one metallic body. The metallic body can be formed as a cylindrical body in one example. In another example, the metallic body can be an irregularly shaped chunk or piece. One of ordinary skill in the art would understand that various shapes for the metallic body can be used. In one aspect, the radar reflective body can be arranged at a center of the core, and the radar reflective body can have an asymmetrical profile.

The radar detectable component can be disposed within at least one channel defined on the radially outermost surface of the core.

In one example, a radially outer surface of the at least one radar detectable component and the radially outermost surface of the core define a contiguous radially outer perimeter of the core.

The radar detectable component can be a non-printed and/or non-ink based radar detectable component.

A method of forming a golf ball with at least one radar detectable component is disclosed herein. The method can comprise (i) forming a core such that at least one radar detectable component is: coincident with a radially outermost surface of the core, or radially inward from the radially outermost surface of the core; and (ii) forming a cover around the core. Additional steps can include forming at least one intermediate layer around the core.

In one example, step (i) can further comprise forming the core from a composition including a base rubber composition and a secondary rubber composition including a radar reflective additive. The two compositions can be configured to form a composite core body, with the secondary rubber composition providing a radar detectable portion of the core body such that various metrics regarding a golf ball can be detected via radar capture devices.

In one example, step (i) can further comprise simultaneously co-molding the core and the radar detectable component with each other. In one aspect, this example can include providing two sub-preps or skinny preps to form a full core body.

In one example, step (i) can further comprise forming the core separately from the radar detectable component. For example, the core can be formed as a spherical body, and subsequently can be modified to remove portions from the spherical body, which are then filled in with radar detectable material to form the radar detectable component.

The radar detectable component can be comprised of at least one radar reflective body, and step (i) can further comprise embedding the at least one radar reflective body within a base rubber material of the core. The at least one radar reflective body can be comprised of at least one metallic body. The metallic body can have a cylindrical profile, in one example.

In another aspect, the radar detectable component can be formed from a radar reflective material, such as a molten radar reflective material, that is deposited into portions of an initial core body and subsequently cooled and hardened.

In one example, step (i) can further comprise forming the core such that at least one channel is defined on the radially outermost surface of the core, and overmolding the radar detectable component with the core such that the radar detectable component at least partially fills the at least one channel.

In one aspect, the radar detectable component is not a printed or ink-based radar detectable component.

U.S. patent application Ser. No. 18/170,251, filed on Feb. 16, 2023, which is incorporated by reference as if fully set forth herein, discloses further arrangements, configurations, and processes for forming a modified segment in a golf ball core.

The following description provides various rubber formulations for the core. The same or similar rubber formulations can be used for the portions of the core that are modified to include the radar detectable component or materials. One of ordinary skill in the art would understand that any of the rubber formulations can be modified to include radar reflective materials, such as at least one of: copper, zinc, magnesium, tungsten, silver, or silver-coated copper.

In some embodiments, the core rubber formulations include a base rubber, a cross-linking agent, and a free radical initiator. It should be understood, however, that not all core rubber formulations that may be used in a core component or element necessarily requires all of these elements. Further, rubber formulations may also optionally include additives, such as one or more of a metal oxide, metal fatty acid or fatty acid, antioxidant, soft and fast agent, or fillers. Concentrations of components are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

The core rubber formulations of the present disclosure can include a base rubber. In some embodiments, the base rubber may include natural and synthetic rubbers and combinations of two or more thereof. Examples of natural and synthetic rubbers suitable for use as the base rubber include, but are not limited to, polybutadiene, polyisoprene, ethylene propylene rubber (EPR), ethylene-propylene-diene (EPDM) rubber, grafted EPDM rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

For example, the core may be formed from a rubber formulation that includes polybutadiene as the base rubber. Polybutadiene is a homopolymer of 1,3-butadiene. The double bonds in the 1,3-butadiene monomer are attacked by catalysts to grow the polymer chain and form a polybutadiene polymer having a desired molecular weight. Any suitable catalyst may be used to synthesize the polybutadiene rubber depending upon the desired properties. In one embodiment, a transition metal complex (for example, neodymium, nickel, or cobalt) or an alkyl metal such as alkyl lithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. For example, the polybutadiene rubber may have a 1,4 cis-bond content of at least 40 percent. In another embodiment, the polybutadiene rubber has a 1,4 cis-bond content of greater than 80 percent. In still another embodiment, the polybutadiene rubber has a 1,4 cis-bond content of greater than 90 percent. In general, polybutadiene rubbers having a high 1,4 cis-bond content have high tensile strength and rebound.

Examples of commercially available polybutadiene rubbers that can be used in rubber formulations in accordance with the present disclosure, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; KBR 01, NdBr 40, NdBR-45, NdBr 60, KBR 710S, KBR 710H, and KBR 750, available from Kumho Petrochemical Co., Ltd. Of Seoul, South Korea; DIENE 55NF, 70AC, and 320 AC, available from Firestone Polymers of Akron, Ohio; and PBR-Nd Group II and Group III, available from Nizhnekamskneftekhim, Inc. of Nizhnekamsk, Tartarstan Republic.

In another embodiment, the core is formed from a rubber formulation including butyl rubber. Butyl rubber is an elastomeric copolymer of isobutylene and isoprene. Butyl rubber is an amorphous, non-polar polymer with good oxidative and thermal stability, good permanent flexibility, and high moisture and gas resistance. Generally, butyl rubber includes copolymers of about 70 percent to about 99.5 percent by weight of an isoolefin, which has about 4 to 7 carbon atoms, for example, isobutylene, and about 0.5 percent to about 30 percent by weight of a conjugated multiolefin, which has about 4 to 14 carbon atoms, for example, isoprene. The resulting copolymer contains about 85 percent to about 99.8 percent by weight of combined isoolefin and about 0.2 percent to about 15 percent of combined multiolefin. A commercially available butyl rubber suitable for use in rubber formulations in accordance with the present disclosure includes Bayer Butyl 301 manufactured by Bayer AG.

The rubber formulations may include a combination of two or more of the above-described rubbers as the base rubber. In some embodiments, the rubber formulation of the present disclosure includes a blend of different polybutadiene rubbers. In this embodiment, the rubber formulation may include a blend of a first polybutadiene rubber and a second polybutadiene rubber in a ratio of about 5:95 to about 95:5. For example, the rubber formulation may include a first polybutadiene rubber and a second polybutadiene rubber in a ratio of about 10:90 to about 90:10 or about 15:85 to about 85:15 or about 20:80 to about 80:20 or about 30:70 to about 70:30 or about 40:60 to about 60:40. In other embodiments, the rubber formulation may include a blend of more than two polybutadiene rubbers or a blend of polybutadiene rubber(s) with any of the other elastomers discussed above.

In other embodiments, the rubber formulation used to form the core includes a blend of polybutadiene and butyl rubber. In this embodiment, the rubber formulation may include a blend of polybutadiene and butyl rubber in a ratio of about 10:90 to about 90:10. For example, the rubber formulation may include a blend of polybutadiene and butyl rubber in a ratio of about 10:90 to about 90:10 or about 20:80 to about 80:20 or about 30:70 to about 70:30 or about 40:60 to about 60:40. In other embodiments, the rubber formulation may include polybutadiene and/or butyl rubber in a blend with any of the other elastomers discussed above.

In further embodiments, the rubber formulation used to form the core includes a blend of polybutadiene and EPDM rubber or grafted EPDM rubber as the base rubber. In still further embodiments, the rubber formulations may include a combination of polybutadiene rubber and EPDM rubber as the base rubber. In this embodiment, the EPDM may be included in the rubber formulation in an amount of about 0.1 to about 20 or about 1 to about 15 or about 3 to about 10 parts by weight per 100 parts of the total rubber. For example, EPDM may be included in the rubber formulation in an amount of about 5 parts by weight per 100 parts of the total rubber. In still further embodiments, the core formulations may combine EPDM rubber and two or more different types of polybutadiene rubber, such as two or more different types of high cis- 1,4 polybutadiene, as the base rubber.

The rubber formulations include the base rubber in an amount of 100 phr. That is, when more than one rubber component is used in the rubber formulation as the base rubber, the sum of the amounts of each rubber component should total 100 phr. In some embodiments, the rubber formulations include polybutadiene rubber as the base rubber in an amount of 100 phr. In other embodiments, the rubber formulations include polybutadiene rubber and a second rubber component. In this embodiment, the polybutadiene rubber may be used in an amount of about 80 to about 99.9 parts by weight per 100 parts of the total rubber and the second rubber component may be used in an amount of about 0.1 to about 20 parts by weight per 100 parts of the total rubber. In further embodiments, the polybutadiene rubber may be used in an amount of about 85 to about 99 parts by weight per 100 parts of the total rubber and the second rubber component may be used in an amount of about 1 to about 15 parts by weight per 100 parts of the total rubber. In yet other embodiments, the polybutadiene rubber may be used in an amount of about 90 to about 97 parts by weight per 100 parts of the total rubber and the second rubber component may be used in an amount of about 3 to about 10 parts by weight per 100 parts of the total rubber. In still further embodiments, the polybutadiene rubber may be used in an amount of about 94 to about 96 parts by weight per 100 parts of the total rubber and the second rubber component may be used in an amount of about 4 to about 6 parts by weight per 100 parts of the total rubber. In some embodiments, the second rubber component is EPDM rubber.

The base rubber may be used in the rubber formulation in an amount of at least about 5 percent by weight based on total weight of the rubber formulation. In some embodiments, the base rubber is included in the rubber formulation in an amount within a range having a lower limit of about 10 percent or 20 percent or 30 percent or 40 percent or 50 percent or 55 percent and an upper limit of about 60 percent or 70 percent or 80 percent or 90 percent or 95 percent or 100 percent. For example, the base rubber may be present in the rubber formulation in an amount of about 30 percent to about 80 percent by weight based on the total weight of the rubber formulation. In another example, the rubber formulation includes about 40 percent to about 70 percent base rubber based on the total weight of the rubber formulation.

The rubber formulations further may include a reactive cross-linking co-agent. Suitable co-agents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. In one embodiment, the co-agent is one or more metal salts of acrylates, diacrylates, methacrylates, and dimethacrylates, wherein the metal is selected from magnesium, calcium, zinc, aluminum, lithium, and nickel. In another embodiment, the co-agent includes one or more zinc salts of acrylates, diacrylates, methacrylates, and dimethacrylates. For example, the co-agent may be zinc diacrylate (ZDA). In another embodiment, the co-agent may be zinc dimethacrylate (ZDMA). An example of a commercially available zinc diacrylate includes Dymalink® 526 manufactured by Cray Valley.

The co-agent may be included in the rubber formulation in varying amounts depending on the desired characteristics of the golf ball core. For example, the co-agent may be used in an amount of about 5 to about 50 or about 10 to about 45 or about 15 to about 40 parts by weight per 100 parts of the total rubber. In one embodiment, the rubber formulation of the core includes about 35 to about 48 parts by weight co-agent per 100 parts of the total rubber. In another embodiment, the rubber formulation includes about 38 to about 45 or about 39 to about 42 parts by weight co-agent per 100 parts of total rubber. In another embodiment, the co-agent is included in the rubber formulation of the core in an amount of about 29 to about 37 or about 31 to about 35 parts by weight per 100 parts of the total rubber. In still another embodiment, the rubber formulation includes about 25 to about 33 or about 27 to about 31 parts by weight co-agent per 100 parts of the total rubber.

The core formulations may include a free radical initiator selected from an organic peroxide, a high energy radiation source capable of generating free radicals, or a combination thereof. Suitable organic peroxides include, but are not limited to, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof.

Free radical initiators may be present in the rubber formulation in an amount of at least 0.05 parts by weight per 100 parts of the total rubber, or an amount within the range having a lower limit of 0.05 parts or 0.1 parts or 1 part or 1.25 parts or 1.5 parts or 2.5 parts or 5 parts by weight per 100 parts of the total rubber, and an upper limit of 2.5 parts or 3 parts or 5 parts or 6 parts or 10 parts or 15 parts by weight per 100 parts of the total rubber. For example, the rubber formulation may include peroxide free radical initiators in an amount of about 0.1 to about 10 or about 0.5 to about 6 or about 1 to about 5 parts by weight per 100 parts of the total rubber. In another example, the rubber formulation may include peroxide free radical initiators in an amount of about 0.5 to about 2 or about 0.7 to about 1.8 or about 0.8 to about 1.2 or about 1.3 to about 1.7 parts by weight per 100 parts of the total rubber. In yet another example, the rubber formulation may include peroxide free radical initiators in an amount of about 1.5 to about 3 or about 1.7 to about 2.8 or about 1.8 to about 2.2 or about 2.3 to about 2.7 parts by weight per 100 parts of the total rubber.

Radical scavengers such as a halogenated organosulfur, organic disulfide, or inorganic disulfide compounds may also be added to the rubber formulation. In one embodiment, a halogenated organosulfur compound included in the rubber formulation includes, but is not limited to, pentachlorothiophenol (PCTP) and salts of PCTP such as zinc pentachlorothiophenol (ZnPCTP). In another embodiment, ditolyl disulfide, diphenyl disulfide, dixylyl disulfide, 2-nitroresorcinol, and combinations thereof are added to the rubber formulation. An example of a commercially available radical scavenger includes Rhenogran© Zn-PTCP-72 manufactured by Rheine Chemie. The radical scavenger may be included in the rubber formulation in an amount of about 0.3 to about 1 part by weight per 100 parts of the total rubber. In one embodiment, the rubber formulation may include about 0.4 to about 0.9 parts by weight radical scavenger per 100 parts of the total rubber. In another embodiment, the rubber formulation may include about 0.5 to about 0.8 parts by weight radical scavenger per 100 parts of the total rubber.

The rubber formulation may also include filler(s). Suitable non-limiting examples of fillers include carbon black, clay and nanoclay particles, talc, glass (e.g., glass flake, milled glass, and microglass), mica and mica-based pigments (e.g., Iriodin® pearl luster pigments from The Merck Group), and combinations thereof.

Metal oxide and metal sulfate fillers are also contemplated for inclusion in the rubber formulation. Suitable metal fillers include, for example, particulate, powders, flakes, and fibers of copper, steel, brass, tungsten, titanium, aluminum, magnesium, molybdenum, cobalt, nickel, iron, lead, tin, zinc, barium, bismuth, bronze, silver, gold, and platinum, and alloys and combinations thereof. Suitable metal oxide fillers include, for example, zinc oxide, iron oxide, aluminum oxide, titanium oxide, magnesium oxide, and zirconium oxide. Suitable metal sulfate fillers include, for example, barium sulfate and strontium sulfate.

In one aspect, fillers can be incorporated into any layer of the golf ball in a relatively lower quantity, such that the fillers are not sufficiently present to provide a radar detectable feature. In another aspect, fillers can be incorporated into any layer of the golf ball in a relatively higher quantity, such that the fillers are detectable via radar. A mixture of fillers, including some at a sufficient quantity and/or of a suitable material to provide radar reflective aspects and some that are not radar reflective, can be used.

In one aspect in which the fillers are provided for non-radar detecting purposes, the fillers may be in an amount of about 1 to about 25 parts by weight per 100 parts of the total rubber. In one embodiment, the rubber formulation includes at least one filler in an amount of about 5 to about 20 or about 8 to about 15 parts by weight per 100 parts of the total rubber. In another embodiment, the rubber formulation includes at least one filler in an amount of about 8 to about 14 or about 10 to about 12 parts by weight per 100 parts of the total rubber. In yet another embodiment, the rubber formulation includes at least one filler in an amount of about 10 to about 17 or about 12 to about 15 parts by weight per 100 parts of the total rubber. In yet another embodiment, the rubber formulation includes at least one filler in an amount of about 10 to about 16 or about 12 to about 15 parts by weight per 100 parts of the total rubber. In a further embodiment, the rubber formulation includes at least one filler in an amount of about 12 to about 18 or about 14 to about 16 parts by weight per 100 parts of the total rubber.

In another aspect in which a filler is provided for radar detectability purposes, the radar reflective filler can be provided in a concentration of at least 25 phr. In another aspect, the radar reflective filler can be provided in a concentration of at least 35 phr. One of ordinary skill in the art would understand that at least two types of filler (i.e., non-radar reflective filler and radar reflective filler) can be used in the golf ball.

In some embodiments, more than one type of filler may be included in the rubber formulation. For example, the rubber formulation may include a first filler in an amount from about 5 to about 20 or about 8 to about 17 parts by weight per 100 parts total rubber and a second filler in an amount from about 1 to about 10 or about 3 to about 7 parts by weight per 100 parts total rubber. In another example, the rubber formulation may include a first filler in an amount from about 7 to about 13 or about 9 to about 12 parts by weight per 100 parts total rubber and a second filler in an amount from about 2 to about 8 or about 4 to about 6 parts by weight per 100 parts total rubber. In yet another example, the rubber formulation may include a first filler in an amount from about 10 to about 15 or about 13 to about 14 parts by weight per 100 parts total rubber and a second filler in an amount from about 2 to about 9 or about 3 to about 7 parts by weight per 100 parts total rubber. In a further example, the rubber formulation may include a first filler in an amount from about 10 to about 15 or about 13 to about 14 parts by weight per 100 parts total rubber and a second filler in an amount from about 13 to about 18 or about 14 to about 16 parts by weight per 100 parts total rubber.

Antioxidants, processing aids, accelerators (for example, tetra methylthiuram), dyes and pigments, wetting agents, surfactants, plasticizers, coloring agents, fluorescent agents, chemical blowing and foaming agents, defoaming agents, stabilizers, softening agents, impact modifiers, antiozonants, as well as other additives known in the art, may also be added to the rubber formulation. Examples of suitable processing aids include, but are not limited to, high molecular weight organic acids and salts thereof. Suitable organic acids are aliphatic organic acids, aromatic organic acids, saturated mono-functional organic acids, unsaturated monofunctional organic acids, multi-unsaturated mono-functional organic acids, and dimerized derivatives thereof. In one embodiment, the organic acids include, but are not limited to, caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, and dimerized derivatives thereof. The salts of organic acids include the salts of barium, lithium, sodium, zinc, bismuth, chromium, cobalt, copper, potassium, strontium, titanium, tungsten, magnesium, cesium, iron, nickel, silver, aluminum, tin, or calcium, salts of fatty acids, particularly stearic, behenic, erucic, oleic, linoelic or dimerized derivatives thereof.

The base rubber, cross-linking agent, free radical initiator, fillers, and any other materials used in forming the core, in accordance with the present disclosure, may be combined to form a mixture by any type of mixing known to one of ordinary skill in the art. Suitable types of mixing include single pass and multi-pass mixing, and the like. A single pass mixing process where ingredients are added sequentially is preferred, as this type of mixing tends to increase efficiency and reduce costs for the process.

The rubber formulation may be cured using conventional curing processes. Non-limiting examples of curing processes suitable for use in accordance with the present disclosure include peroxide-curing, sulfur-curing, high-energy radiation, and combinations thereof.

Any one or more of the steps of forming the core of the golf ball can include various molding techniques, such as compression molding, flip molding, injection molding, retractable pin injection molding (RPIM), reaction injection molding (RIM), liquid injection molding (LIM), casting, vacuum forming, powder coating, flow coating, spin coating, dipping, spraying, and the like. Other exemplary formation techniques are disclosed in U.S. Patent Application Pub. 2022/0143470, U.S. Patent Application Pub. 2022/0062711, U.S. Pat. Nos. 7,033,532, 7,407,378, 6,797,097, and 7,335,326, which are each incorporated by reference in their entirety as if fully set forth herein.

In examples in which the core and the radar detectable component are both formed from a rubber material and molded with each other, one of ordinary skill in the art would understand that further steps can be performed, such as centerless grinding or wet-grinding processes, can be carried out to ensure the core with the integrated radar detectable component is smooth, spherical, and the correct size according to precise specifications.

In some aspects, the material for forming the radar detectable component can be a combination of a rubber composition and radar reflective material, entirely radar reflective material, and/or any combination of radar reflective material and a base material or a secondary material. Regardless of the material for forming the radar detectable component, the radar detectable component can be configured to match or mimic the density and/or specific gravity of the remainder of the material used to form the core. In one aspect, the density of the material forming the radar detectable component is no greater than 1% different than the density of the material forming the remainder of the core. In one aspect, the density of the material forming the radar detectable component is no greater than 5% different than the density of the material forming the remainder of the core. In one aspect, the density of the material forming the radar detectable component is no greater than 50% different than the density of the material forming the remainder of the core. In one aspect, the golf ball has a weight distribution that is symmetrical or balanced. In one aspect, the core including the radar reflective material may be heavier than a typical golf ball construction. In this aspect, the material used to form the casing and/or cover can be selected such that the total weight of the golf ball is conforming according to the USGA standard. In another aspect, the golf ball can have a non-conforming weight according to the USGA standard.

In another aspect, a golf ball can be provided that has a dual core or multi-layer core. In one example, an inner core layer includes the radar detectable component and a rubber composition, and an outer core layer is formed from a rubber composition and lacks any radar detectable component. In one example, an outer core layer includes the radar detectable component and a rubber composition, and an inner core layer is formed from a rubber composition and lacks any radar detectable component. One of ordinary skill in the art would understand that the material selections for the core layers can vary to ensure that the overall weight of the golf ball is conforming.

The present invention is not meant to be limited by the material used to form each layer of the golf ball. Particularly suitable materials include, but are not limited to, thermosetting materials, such as polybutadiene, styrene butadiene, isoprene, polyisoprene, and trans-isoprene; thermoplastics, such as ionomer resins, polyamides and polyesters; and thermoplastic and thermosetting polyurethane and polyureas.

Particularly suitable thermosetting materials, include, but are not limited to, thermosetting rubber compositions comprising a base polymer, an initiator agent, a coagent and/or a curing agent, and optionally one or more of a metal oxide, metal fatty acid or fatty acid, antioxidant, soft and fast agent, fillers, and additives. Suitable base polymers include natural and synthetic rubbers including, but not limited to, polybutadiene, polyisoprene, ethylene propylene rubber (“EPR”), styrene-butadiene rubber, styrenic block copolymer rubbers (such as SI, SIS, SB, SBS, SIBS, and the like, where “S” is styrene, “I” is isobutylene, and “B” is butadiene), butyl rubber, halobutyl rubber, polystyrene elastomers, polyethylene elastomers, polyurethane elastomers, polyurea elastomers, metallocene-catalyzed elastomers and plastomers, copolymers of isobutylene and para-alkylstyrene, halogenated copolymers of isobutylene and para-alkylstyrene, acrylonitrile butadiene rubber, polychloroprene, alkyl acrylate rubber, chlorinated isoprene rubber, acrylonitrile chlorinated isoprene rubber, polyalkenamers, and combinations of two or more thereof. Suitable initiator agents include organic peroxides, high energy radiation sources capable of generating free radicals, C—C initiators, and combinations thereof. Suitable coagents include, but are not limited to, metal salts of unsaturated carboxylic acids; unsaturated vinyl compounds and polyfunctional monomers (e.g., trimethylolpropane trimethacrylate); phenylene bismaleimide; and combinations thereof. Suitable curing agents include, but are not limited to, sulfur; N-oxydiethylene 2-benzothiazole sulfenamide; N,N-di-ortho-tolylguanidine; bismuth dimethyldithiocarbamate; N-cyclohexyl 2-benzothiazole sulfenamide; N,N-diphenylguanidine; 4-morpholinyl-2-benzothiazole disulfide; dipentamethylenethiuram hexasulfide; thiuram disulfides; mercaptobenzothiazoles; sulfenamides; dithiocarbamates; thiuram sulfides; guanidines; thioureas; xanthates; dithiophosphates; aldehyde-amines; dibenzothiazyl disulfide; tetraethylthiuram disulfide; tetrabutylthiuram disulfide; and combinations thereof. Suitable types and amounts of base polymer, initiator agent, coagent, filler, and additives are more fully described in, for example, U.S. Pat. Nos. 6,566,483, 6,695,718, 6,939,907, 7,041,721 and 7,138,460, the entire disclosures of which are hereby incorporated herein by reference. Particularly suitable diene rubber compositions are further disclosed, for example, in U.S. Patent Application Publication 2007/0093318, the entire disclosure of which is hereby incorporated herein by reference.

Particularly suitable materials also include, but are not limited to: a) thermosetting polyurethanes, polyureas, and hybrids of polyurethane and polyurea; b) thermoplastic polyurethanes, polyureas, and hybrids of polyurethane and polyurea, including, for example, Estane® TPU, commercially available from The Lubrizol Corporation; c) E/X- and E/X/Y-type ionomers, wherein E is an olefin (e.g., ethylene), X is a carboxylic acid (e.g., acrylic, methacrylic, crotonic, maleic, fumaric, or itaconic acid), and Y is a softening comonomer (e.g., vinyl esters of aliphatic carboxylic acids wherein the acid has from 2 to 10 carbons, alkyl ethers wherein the alkyl group has from 1 to 10 carbons, and alkyl alkylacrylates such as alkyl methacrylates wherein the alkyl group has from 1 to 10 carbons), such as Surlyn® ionomer resins and HPF 1000 and HPF 2000, commercially available from The Dow Chemical Company, Iotek® ionomers, commercially available from ExxonMobil Chemical Company, Amplify® IO ionomers of ethylene acrylic acid copolymers, commercially available from The Dow Chemical Company, and Clarix® ionomer resins, commercially available from A. Schulman Inc.; d) polyisoprene; e) polyoctenamer, such as Vestenamer® polyoctenamer, commercially available from Evonik Industries; f) polyethylene, including, for example, low density polyethylene, linear low density polyethylene, and high density polyethylene; polypropylene; g) rubber-toughened olefin polymers; non-ionomeric acid copolymers, e.g., (meth)acrylic acid, which do not become part of an ionomeric copolymer; h) plastomers; i) flexomers; j) styrene/butadiene/styrene block copolymers; k) styrene/ethylene-butylene/styrene block copolymers; l) polybutadiene; m) styrene butadiene rubber; n) ethylene propylene rubber; o) ethylene propylene diene rubber; p) dynamically vulcanized elastomers; q) ethylene vinyl acetates; r) ethylene (meth) acrylates; s) polyvinyl chloride resins; t) polyamides, amide-ester elastomers, and copolymers of ionomer and polyamide, including, for example, Pebax® thermoplastic polyether and polyester amides, commercially available from Arkema Inc; u) crosslinked trans-polyisoprene; v) polyester-based thermoplastic elastomers, such as Hytrel® polyester elastomers, commercially available from E. I. du Pont de Nemours and Company, and Riteflex® polyester elastomers, commercially available from Ticona; w) polyurethane-based thermoplastic elastomers, such as Elastollan® polyurethanes, commercially available from BASF; x) synthetic or natural vulcanized rubber; and y) combinations thereof.

Compositions comprising an ionomer or a blend of two or more E/X- and E/X/Y-type ionomers are particularly suitable intermediate and cover layer materials. Preferred E/X- and E/X/Y-type ionomeric cover compositions include: (a) a composition comprising a “high acid ionomer” (i.e., having an acid content of greater than 16 wt %), such as Surlyn® 8150; (b) a composition comprising a high acid ionomer and a maleic anhydride-grafted non-ionomeric polymer (e.g., Fusabond® functionalized polymers). A particularly preferred blend of high acid ionomer and maleic anhydride-grafted polymer is a 84 wt %/16 wt % blend of Surlyn® 8150 and Fusabond®. Blends of high acid ionomers with maleic anhydride-grafted polymers are further disclosed, for example, in U.S. Pat. Nos. 6,992,135 and 6,677,401, the entire disclosures of which are hereby incorporated herein by reference; (c) a composition comprising a 50/45/5 blend of Surlyn® 8940/Surlyn® 9650/Nucrel® 960, preferably having a material hardness of from 80 to 85 Shore C; (d) a composition comprising a 50/25/25 blend of Surlyn® 8940/Surlyn® 9650/Surlyn® 9910, preferably having a material hardness of about 90 Shore C; (e) a composition comprising a 50/50 blend of Surlyn® 8940/Surlyn® 9650, preferably having a material hardness of about 86 Shore C; (f) a composition comprising a blend of Surlyn® 7940/Surlyn® 8940, optionally including a melt flow modifier; (g) a composition comprising a blend of a first high acid ionomer and a second high acid ionomer, wherein the first high acid ionomer is neutralized with a different cation than the second high acid ionomer (e.g., 50/50 blend of Surlyn® 8150 and Surlyn® 9120), optionally including one or more melt flow modifiers such as an ionomer, ethylene-acid copolymer or ester terpolymer; and (h) a composition comprising a blend of a first high acid ionomer and a second high acid ionomer, wherein the first high acid ionomer is neutralized with a different cation than the second high acid ionomer, and from 0 to 10 wt % of an ethylene/acid/ester ionomer wherein the ethylene/acid/ester ionomer is neutralized with the same cation as either the first high acid ionomer or the second high acid ionomer or a different cation than the first and second high acid ionomers (e.g., a blend of 40-50 wt % Surlyn® 8140 or 8150, 40-50 wt % Surlyn® 9120, and 0-10 wt % Surlyn® 6320).

Surlyn 8150®, Surlyn® 8940, and Surlyn® 8140 are different grades of E/MAA copolymer in which the acid groups have been partially neutralized with sodium ions. Surlyn® 9650, Surlyn® 9910, and Surlyn® 9120 are different grades of E/MAA copolymer in which the acid groups have been partially neutralized with zinc ions. Surlyn® 7940 is an E/MAA copolymer in which the acid groups have been partially neutralized with lithium ions. Surlyn® 6320 is a very low modulus magnesium ionomer with a medium acid content. Nucrel® 960 is an E/MAA copolymer resin nominally made with 15 wt % methacrylic acid. Surlyn® ionomers, Fusabond® polymers, and Nucrel® copolymers are commercially available from The Dow Chemical Company.

Suitable E/X- and E/X/Y-type ionomeric cover materials are further disclosed, for example, in U.S. Pat. Nos. 6,653,382, 6,756,436, 6,894,098, 6,919,393, and 6,953,820, the entire disclosures of which are hereby incorporated by reference.

Suitable polyurethanes, polyureas, and blends and hybrids of polyurethane/polyurea are further disclosed, for example, in U.S. Pat. Nos. 5,334,673, 5,484,870, 6,506,851, 6,756,436, 6,835,794, 6,867,279, 6,960,630, and 7,105,623; U.S. Patent Application Publication 2009/0011868; U.S. Patent Application Publication 2021/0093929; U.S. Patent Application Publication 2007/0117923; and U.S. Pat. Nos. 8,865,052, 6,734,273, and 8,034,873; the entire disclosures of which are hereby incorporated herein by reference.

Suitable UV absorbers that are optionally included in cover layer compositions are further disclosed, for example, in U.S. Pat. Nos. 5,156,405, 5,840,788, and 7,722,483; the entire disclosures of which are hereby incorporated herein by reference.

In some aspects, the term radar reflective material can refer to an electrically conductive material, which can include silver, conductive carbon, aluminum, graphene, nanotubes, nanometals, and combinations of two or more thereof. One of ordinary skill in the art would understand that various other materials could be used for the radar reflective material.

In one aspect, the radar reflective material has a resistivity of 0.1 Ohms or 0.5 Ohms or 1 Ohm or 5 Ohms or 6 Ohms or 7 Ohms or 25 Ohms or 2,500 Ohms, or a resistivity within a range having a lower limit and an upper limit selected from these values. One of ordinary skill in the art would understand that other resistivity values could be used.

Dimensions of each golf ball layer, i.e., thickness/diameter, may vary depending on the desired properties.

In one aspect, the radar detectable features disclosed herein can be compatible with a TrackMan® system, commercially available from TrackMan® Golf. One of ordinary skill in the art would understand that the golf balls disclosed herein can be compatible with other golf ball tracking systems.

In one aspect, the radar detectable features disclosed herein are configured to provide reliable launch condition data. In one aspect, the radar detectable features disclosed herein are configured to provide reliable data regarding spin, launch angle, speed, rotation, and other metrics of a golf ball that has been struck.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure.

The golf balls described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the device in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety.

What is claimed is:

1. A golf ball comprising:
a core comprising at least one radar detectable component,
the core defining a radially outermost surface and the at least one radar detectable component being radially inward from the radially outermost surface such that a gap is defined between the radially outermost surface of the core and the at least one radar detectable component; and
a cover disposed around the core.

2. The golf ball according to claim 1, wherein the at least one radar detectable component is comprised of a composition including a base rubber composition and a secondary rubber composition including a radar reflective additive.

3. The golf ball according to claim 2, wherein the base rubber composition and the secondary rubber composition are simultaneously co-molded with each other.

4. The golf ball according to claim 2, wherein the base rubber composition is molded during a first molding step, and the secondary rubber composition is molded during a second molding step that is separate from the first molding step.

5. The golf ball according to claim 1, wherein the at least one radar detectable component is comprised of at least one radar reflective body that is embedded within a base rubber material of the core.

6. The golf ball according to claim 5, wherein the at least one radar reflective body includes at least one metallic body.

7. The golf ball according to claim 5, wherein the at least one radar reflective body includes a plurality of radar reflective bodies.

8. The golf ball according to claim 7, wherein the plurality of radar reflective bodies is comprised of a first radar reflective body arranged at a first radial depth within the core and a second radar reflective body arranged at a second radial depth within the core, and the first and second radial depths are different.

9. The golf ball according to claim 1, further comprising at least one layer disposed between the core and the cover.

10. The golf ball according to claim 1, wherein the at least one radar detectable component is not a printed radar detectable component, and is not an ink-based radar detectable component.

11. A golf ball comprising:
a core comprising at least one radar detectable component,
the core defining a radially outermost surface and the at least one radar detectable component being coincident with at least a portion of the radially outermost surface, wherein the at least one radar detectable component is disposed within at least one channel defined on the radially outermost surface of the core and the at least one radar detectable component fills an entirety of the at least one channel; and
a cover disposed around the core.

12. The golf ball according to claim 11, wherein a radially outer surface of the at least one radar detectable component and the radially outermost surface of the core define a contiguous radially outer perimeter of the core.

13. The golf ball according to claim 11, wherein the at least one channel is formed via molding of the core.

14. A method of forming a golf ball with at least one radar detectable component, the method comprising:
(i) forming a core such that at least one radar detectable component is radially inward from a radially outermost surface of the core; and
(ii) forming a cover around the core.

15. The method according to claim 14, wherein step (i) comprises forming the core from a composition including a base rubber composition and a secondary rubber composition including a radar reflective additive.

16. The method according to claim 14, wherein step (i) comprises simultaneously co-molding the core and the at least one radar detectable component with each other.

17. The method according to claim 14, wherein the at least one radar detectable component is comprised of at least one radar reflective body, and step (i) comprises embedding the at least one radar reflective body within a base rubber material of the core.

18. The method according to claim 14, wherein the at least one radar detectable component is comprised of a plurality of radar reflective bodies, and step (i) comprises embedding the plurality of radar reflective bodies within a base rubber material of the core.

19. The method according to claim 18, wherein the plurality of radar reflective bodies are comprised of a first radar reflective body and a second radar reflective body, wherein the first radar reflective body is arranged at a first radial depth within the core and the second radar reflective body is arranged at a second radial depth within the core, and the first and second radial depths are different.

20. The method according to claim 14, wherein the at least one radar detectable component is not a printed radar detectable component, and is not an ink-based radar detectable component.
